(19) United States
(12) Patent Application Publication
(10) Pub. No.: US 2015/0088474 A1
(43) Pub. Date: Mar. 26, 2015

(54) VIRTUAL SIMULATION

(71) Applicant: Ford Global Technologies, LLC, Dearborn, MI (US)

(72) Inventors: Adam L. Frost, Maribyrnong (AU); Jonathan L. Petrovski, Point Cook (AU)

(73) Assignee: Ford Global Technologies, LLC, Dearlborn, MI (US)

(21) Appl. No.: 14/036,441

(22) Filed: Sep. 25, 2013

(51) Int. Cl. G06F 17/50

(52) U.S. Cl. CPC G06F 17/5009
USPC 703/6

(57) ABSTRACT

A set of files is in a first format resulting from running a computer simulation. A sequence of the files is created based on an order in which the files relate to the simulation. The files are converted from the first format to a second format, the second format being usable for rendering the files by a virtual reality tool. A virtual simulation is run in a virtual reality environment using the converted files.

### BACKGROUND INFORMATION

Current virtual reality tools immerse a person into a virtual environment that provides for interaction with, and viewing of, various virtual objects, such as an object generated from a static three-dimensional computer aided design (CAD) file. Hence such tools are limited to non-moving, static product geometry in the virtual environment.

Virtual design of a vehicle or an industrial system is heavily reliant on computer simulation to predict and develop functional performance. However, at present, computer aided engineering (CAE) may be based on viewing a complex physical event (e.g., a simulated moving animation) on a computer monitor with a limited field of view, and with a viewpoint controlled by a user's mouse and keyboard. Hence, it can be difficult to grasp interactions of an event on a computer monitor. A user cannot view an event from any desired angle or viewpoint. Accordingly, at present, simulation of events such as, to take just one example, a vehicle crash test, is limited. For example, post-event, e.g., post-crash, physical analyses are limited to the final outcome of the crash event, with no ability to “rewind” what occurred or to “walk around” the dangerous event/test while it is occurring etc. generally, a full understanding of an event/test is not possible until actual physical prototypes can be made available and tested, which delays and increases costs of product development, sometimes by months or even years.

### BRIEF DESCRIPTION OF THE DRAWINGS

FIG. 1 is a block diagram of an exemplary system for providing a virtual simulation.

FIG. 2 is a block diagram illustrating an exemplary implementation of a virtual reality generator.

FIG. 3 illustrates exemplary vehicle exterior computer-aided design (CAD) surface geometries.

FIG. 4 illustrates exemplary FEA mesh geometries.

FIG. 5 illustrates a rendering of an exemplary computer engineering (CAE) model of a complete vehicle.

FIG. 6 illustrates selected geometries as could be displayed from an exemplary simulation.

FIG. 7 shows selected geometries as could be displayed from an exemplary simulation rendered in the context of a virtual reality including background elements of a virtual world.

FIG. 8 shows selected geometries representing top and bottom perspectives of an exemplary simulation rendered in the context of a virtual reality including background elements of a virtual world.

FIG. 9 illustrates a process flow diagram of an exemplary process for providing a virtual simulation.

FIG. 10 illustrates a process flow diagram of an exemplary process for generating a virtual simulation from a CAE simulation.

### DETAILED DESCRIPTION OF PREFERRED EMBODIMENTS

### Introduction

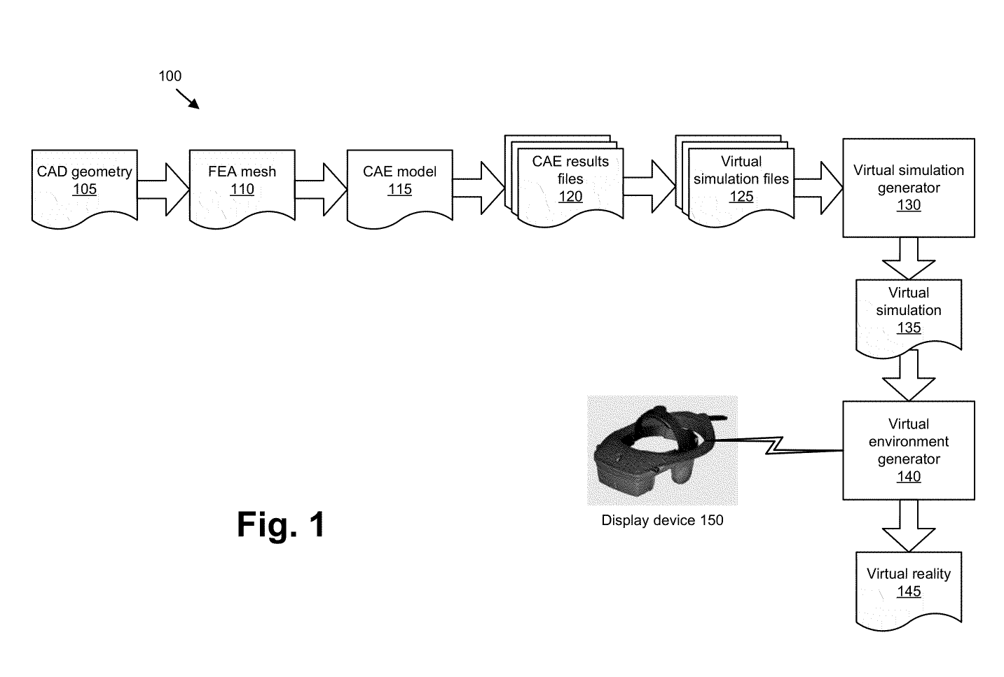

FIG. 1 illustrates an exemplary system 100 for providing a virtual simulation. In general, the system 100 provides a virtual simulation generator 130 that receives inputs including virtual simulation files 125 generated from computer aided engineering (CAE) simulation results files 120, and provides a virtual simulation 135. A virtual reality generator 140 generates a virtual reality 145 that may include the virtual simulation 135. Accordingly, a person who is immersed in the virtual environment 150 including the virtual simulation 135 can visualise and interact with computer aided engineering (CAE) simulation results, i.e., the virtual simulation 135. For example, suppose that CAE results files 120 include 100 frames of data representing 100 milliseconds of a simulated crash test event. After conversion to virtual simulation files 125, the virtual simulation generator 130 could include these frames of data in a virtual simulation 135. In general, the virtual simulation generator 130 makes possible providing a wide variety of simulations 135, including animations of various events, in the virtual reality 145.

As alluded to above, an exemplary implementation of the system 100 may be used for a virtual crash simulation. For example, a person immersed in the virtual reality 145 including a virtual simulation 135 can sit inside a virtual vehicle during a simulated crash event. Such a user can thus experience and observe deformation that occurs during the crash event, e.g., using a display device 150 such as a head-mounted 3D viewer, 2D/3D televisions/monitors, etc.

Further, a user could stand near, e.g., in front of, behind, inside, underneath, etc., a simulated crash as it occurred thus obtaining a view of a crash from a perspective that would be too dangerous during an actual test. Additionally or alternatively, a user may slow, pause, rewind, etc. a simulation 135 including a crash event, thereby allowing the user to gain addition perspective on the event, e.g., to virtually walk around a crash event to observe design performance and/or issues that may be missed on a monitor with limitations imposed by a keyboard, mouse, field-of-view, etc. Stepping outside of the crash test example, other kinds of simulations 135 provide similar benefits. For example, a virtual durability test simulation 135 allows a user to view interior product parts as they deform and interact during a test in a way not possible in a physical test. Returning to the crash test example, crash simulation result detail could be overlaid on moving geometry, e.g., stress, strain, displacement color graduations, etc., can be included in a virtual simulation 135 and shown in real time.

### Exemplary System Elements

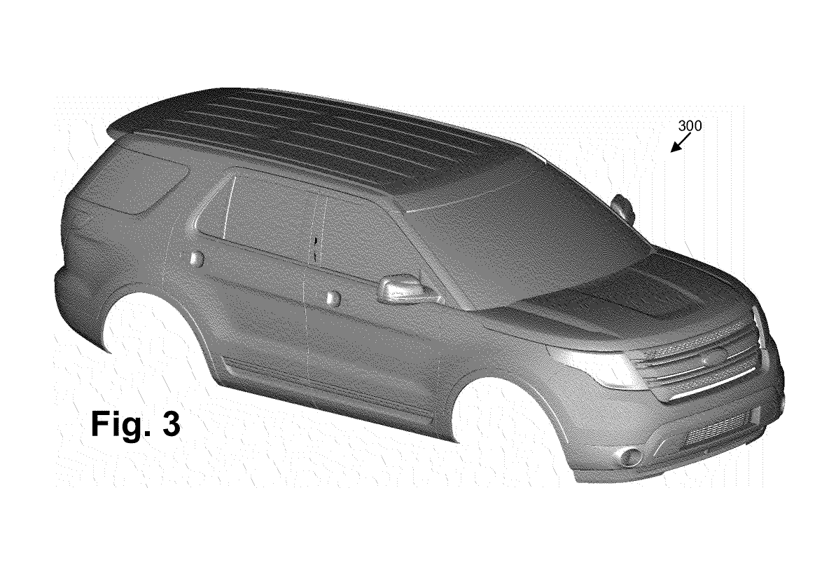

The system 100 may include one or more with a computer aided design (CAD) geometries 105, sometimes referred to as CAD files, for a product such as a vehicle. FIG. 3 illustrates an exemplary vehicle exterior surface geometry 300.

As is known, a CAD geometry 105 may be used to provide surface geometries for a virtual product model. Developing surface geometries is typically the first step in the geometric development of a product such as vehicle. The production design of individual vehicle components is derived from surface geometries in either the partial form of the individual component or in the location and size of the individual component within the boundaries defined by a surface geometry. As is known, surface geometries define the shape, form, and dimensions of visible product, e.g. vehicle, surfaces. Surface geometries are typically developed using a commercially available CAD) or digital modeling software executable on a general purpose computer. Examples of commercially available CAD or digital modeling applications that may be used in developing surface geometries include: CATIA V5 by Dassault Systemes of France, AutoStudio by Alias Systems, a subsidiary of Autodesk, Inc. of San Rafael, Calif., ICEM Surf by Dassault Systemes of France, and NX by Siemens PLM, of Germany.

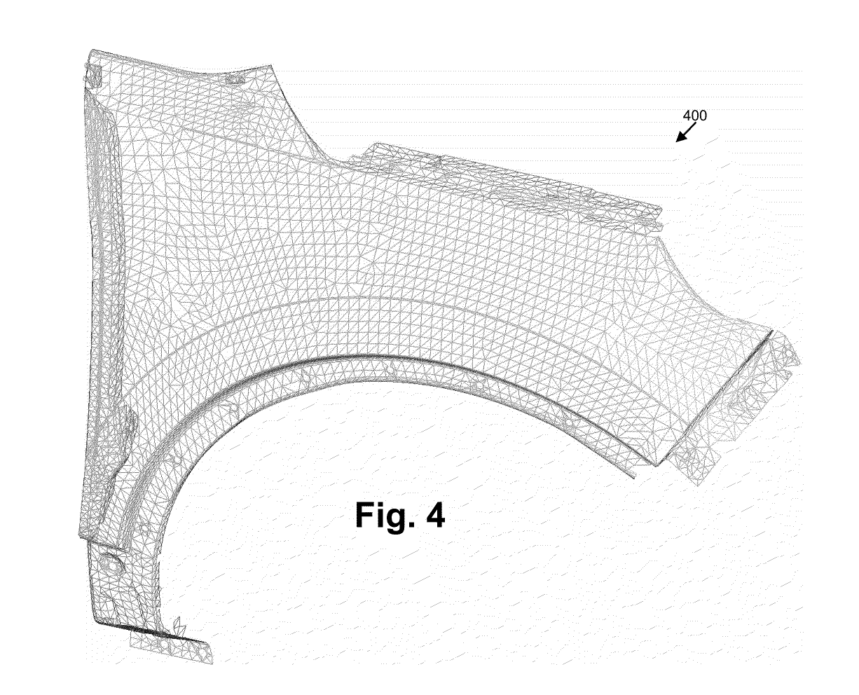

The CAD geometry 105 may be combined with an FEA mesh 110. FIG. 4 illustrates exemplary FEA mesh geometries 400. An FEA mesh 110 defines physical and material properties of the structural components of a product such as a vehicle, as opposed to surface geometries in CAD geometries 105, which define surface characteristics of a vehicle and vehicle components. An FEA mesh 110 is typically developed using commercially available FEA pre-processing software. Examples of commercially available FEA pre-processing software applications used in developing meshes 110 include ANSA by BETA CAE Systems SA, Hypermesh by Altair Engineering Inc., of Troy, Mich., and Femap by Siemens PLM.

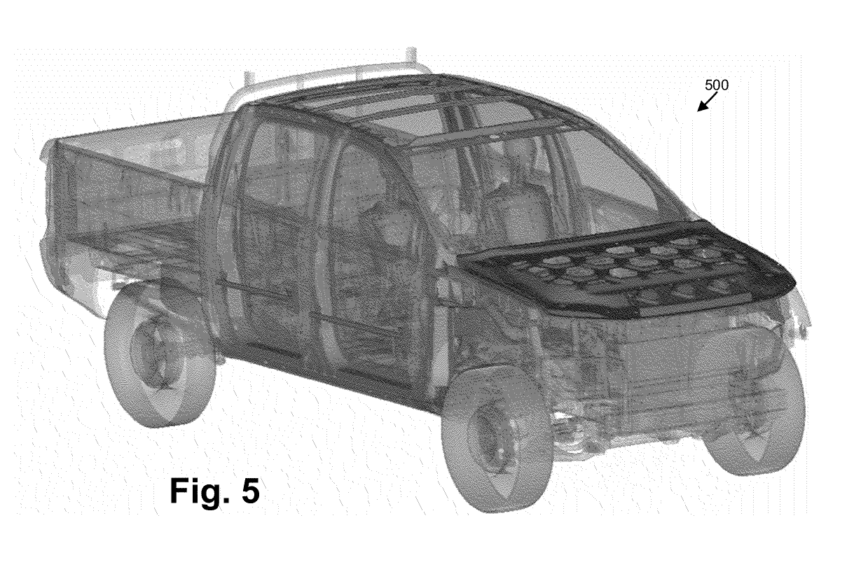

CAD geometries 105 and FEA meshes 110 may be used to create a CAE simulation model 115 in a known manner. FIG. 5 illustrates an exemplary rendering 500 of a CAE model 115 of an entire vehicle. In general, as is known, a CAE model 115 includes surface geometries 105 and also constraints, material properties, forces, velocities, accelerations, etc., represented in the FEA mesh 110. Accordingly, a CAE model 115 could be used to provide an event simulation, e.g., using commercially available software such as LS-DYNA by Livermore Software Technology Corporation, of Livermore Calif. However, such known simulations are burdened by limitations and deficiencies such as mentioned above.

CAE results files 120 generally include a geometry for an item, e.g., a vehicle, after a CAE simulation is run on a model 115. For example, CAE results files 120 may be provided for respective steps or frames output from a CAE simulation. CAE results files 120 are generally in a format appropriate for providing the item geometry output from running the CAE simulation, e.g., virtual reality markup language (VRML).

CAE results files 120 may be converted to virtual simulation files 125 for input to the generator 130. For example, a VRML file 120 could be converted to a format for use by a virtual reality application such as MotionBuilder® and VRED® from Autodesk, Inc. of San Rafael, Calif.; the Visual Decision Platform (VDP) from ICIDO of Stuttgart, Germany; Teamcenter from Siemens AG of Munich, Germany; RTT DeltaGen from Realtime Technology AG of Munich, Germany; etc. For example, a simulation file 125 could be in the FBX format used by MotionBuilder.

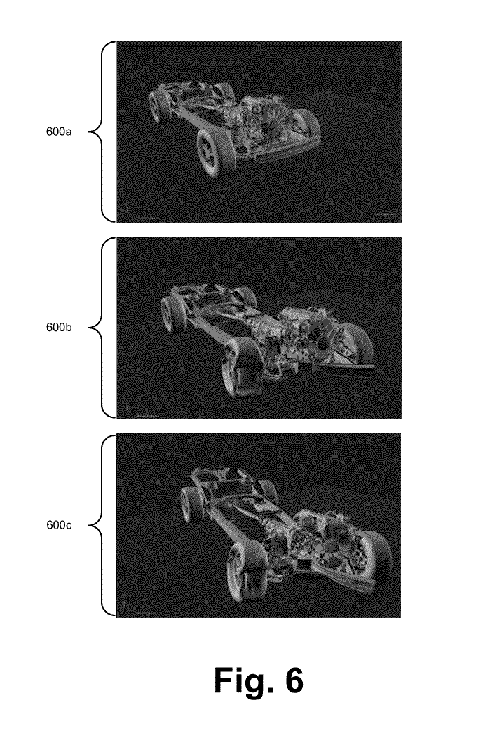

The virtual simulation generator 130 takes virtual simulation files 125 as input, and provides a virtual simulation 135 as output. The virtual simulation 135 includes a sequence of simulation files 125, along with constraints for displaying a simulated event, e.g., in a virtual reality application such as MotionBuilder. Further details of a virtual simulation 135, and processes for generating and using a virtual simulation 135, are described below. FIG. 6 illustrates selected geometries 600a, 600b, and 600c as could be displayed from an exemplary simulation 135.

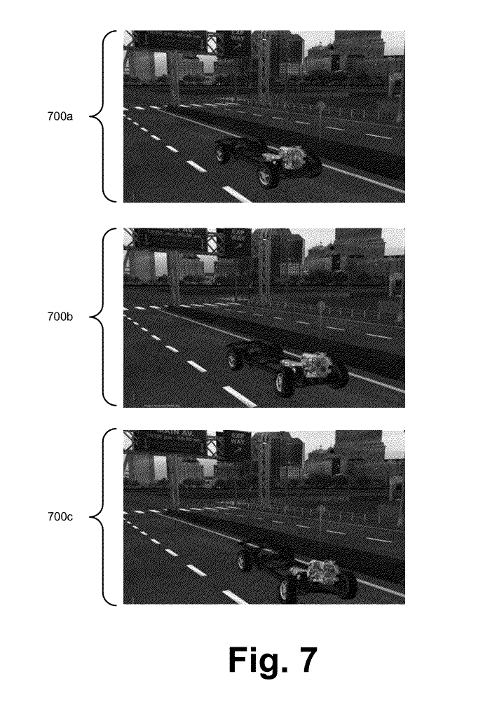

The virtual reality generator 140 generally includes computer hardware and/or software for providing the virtual reality 145. For example, various elements and/or processes disclosed herein, including the virtual reality generator 140 and processes related thereto, may be provided according to computer executable instructions stored and executed on a computer server including a processor and a computer readable medium such as a memory for storing and executing such instructions. FIG. 7 shows selected geometries 700a, 700b, and 700c as could be displayed from an exemplary simulation 135 rendered in the context of a virtual reality 145 including background elements of a virtual world.

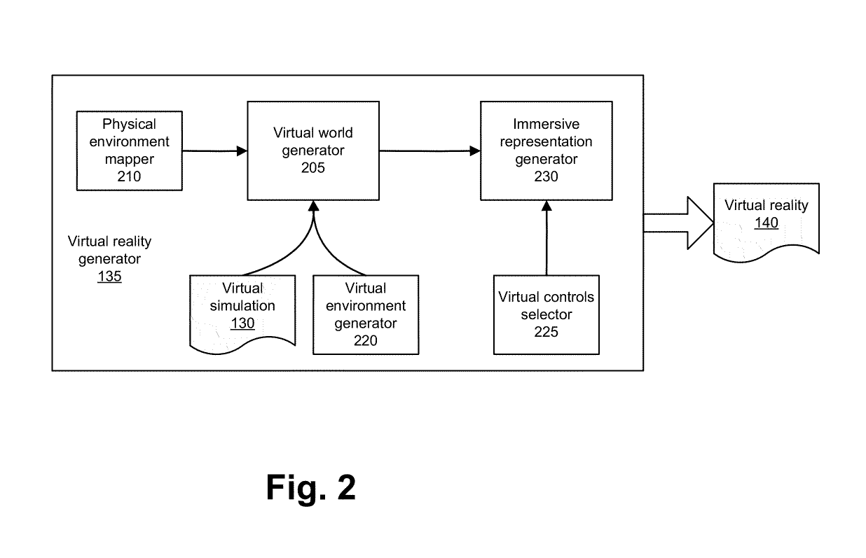

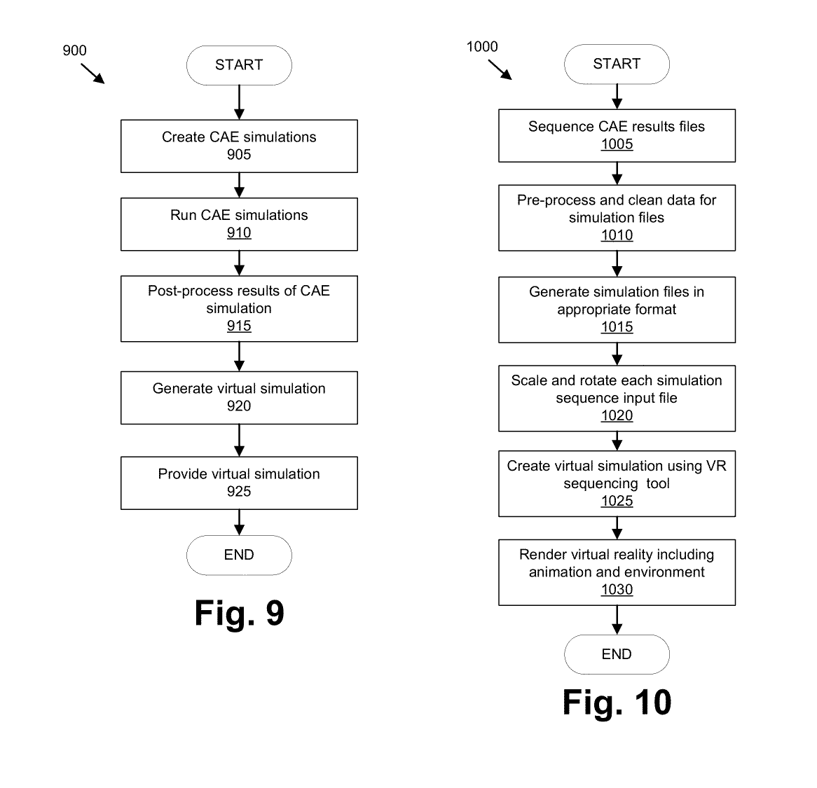

The virtual reality generator 140 may be used to provide a simulation 135 relating to a product or some other item in a virtual reality 145, where the virtual reality 145 may be mapped to a physical environment. Exemplary implementation details of the virtual reality generator 140, and content of the virtual reality 145 are discussed below with respect to FIG. 2. Further, processes for using the virtual reality generator 140 and generating and using the virtual reality 145 are likewise discussed below with respect to FIGS. 9 and 10.

Various kinds of display devices 150 could be used in the system 100, in the system 100 could include one or more display devices 150. For example, a first display device 150 could be a head-mounted display worn by a user and presenting a stereoscopic view of a vehicle, an assembly line, or some other item or environment, and a second display device 150 could be two computer monitors, each presenting one of the two stereoscopic displays provided through the head-mounted display. Display device 150 could also provide audio in addition to visual output. Alternatively or additionally, display device 150 may be a CAVE (CAVE Automated Virtual Environment), a Powerwall (i.e., a large high-resolution display wall used for projecting large computer generated images), a computer monitor such as a high definition television (HDTV), a laptop or tablet computer, etc.

### Virtual Reality Generator

FIG. 2 is a block diagram illustrating an exemplary implementation of a virtual reality generator 140. As illustrated in FIG. 2, a virtual world generator 205 may receive input from a physical environment mapper 210, the virtual simulation generator 130 in the form of a virtual simulation 135, and/or a virtual environment generator 220. Further, an immersive representation generator 230 uses a virtual world generated by virtual world generator 205, along with virtual controls provided by a virtual controls selector 225, e.g., according to program instructions included in the immersive representation generator 230 to provide positioning and orientation in the virtual world, to provide a user with an immersive virtual representation of a vehicle from the user's perspective.

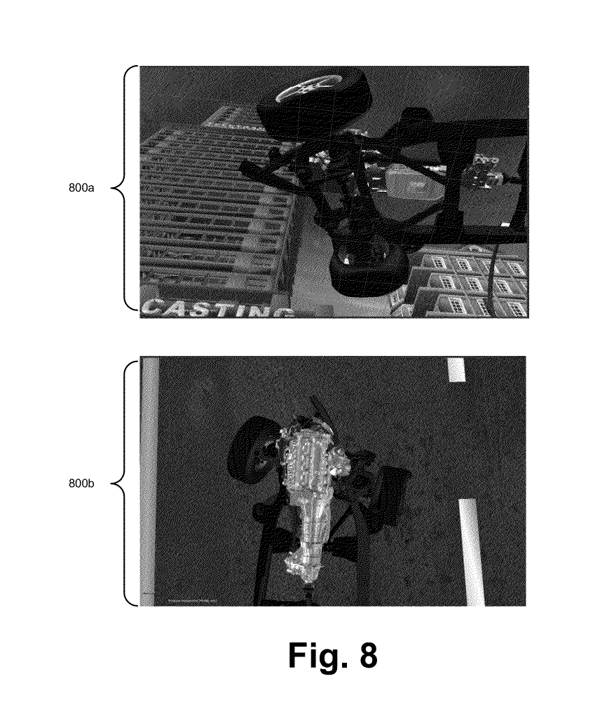

Further, immersive representation generator 230 may provide different user perspectives a virtual world according to a user selection, e.g., via a virtual controls selector 225. For example, a user may be provided different perspectives of a virtual world according to different virtual heights of the user. That is, a user could be given a perspective of a virtual world that a 6′1″ tall person would have, and then, according to a selection of a virtual controls selector 225, begin in a perspective of a virtual world that a 5′4″ person would have. Further, a user may desire one or more different perspectives of an event. For example, a user could desire to view a simulated vehicle crash test from a side of the vehicle, and from above or beneath the vehicle, e.g., as shown in FIG. 8.

In general, ability to provide different user perspectives advantageously allows a user to experience a virtual world, and a vehicle in the virtual world including in a simulation 135 in the virtual reality 145, from the perspective of people with differing virtual attributes and/or desiring differing virtual perspectives. In addition, where multiple displays 150 are provided as part of the system 100, the immersive representation generator 230 may provide different perspectives to different users of the virtual world, e.g., a first user may have a perspective of standing near the hood of a virtual product included in a simulation 135, while a second user may have a perspective of standing behind the virtual product. FIG. 8 shows selected geometries 800a, F00b top and bottom perspectives of an exemplary simulation 135 rendered in the context of a virtual reality 145 including background elements of a virtual world.

Physical environment mapper 210 is an optional component that is used to register a virtual reality coordinate system to real world, i.e., physical, objects. For example, a vehicle mockup may be provided with various points such as seats, a dashboard, steering wheel, instrument panel, etc. Accordingly, to allow a user of display device 150 to interact with the virtual world provided by virtual world generator 205 and immersive representation generator 230, physical environment mapper 210 may be used to map points in a physical framework, e.g., a mockup of a vehicle, to a coordinate system used by the virtual world generator 205. For example, points may be oriented with respect to the ground, and may include vehicle points based on vehicle dimensions such as height of the vehicle from the ground, height of doors, interior width at various points, etc. Further, coordinate system used by physical environment mapper 210 may include a mechanism for scaling a virtual world to properly mapped to the coordinate system for the physical world.

To be used by the virtual world generator 205, simulation files 125 included in a virtual simulation 135 make use of what is sometimes referred to as a nominal geometry, i.e., a geometry that provides all of the basic elements of a product such as a vehicle. Further, the nominal geometry includes coordinate information for various product components.

Virtual environment generator 220 is used to generate aspects of a virtual world other than a product, e.g., a vehicle, representation. For example, virtual environment generator 220 receives input with respect to lighting in a virtual world, illustrates shadows and reflections, and provides perspective and provides background geometry to complete the user's virtual world, e.g., to determine a setting in which a virtual product 103 is experienced, e.g., a cityscape, a rural setting, etc. With respect to lighting, ray tracing, which calculates how light bounces from one surface to another, may be important, and may enhance a virtual representation. With respect to perspective, virtual environment generator 220 may provide a perspective for a person of a certain height. As mentioned above, immersive representation generator 230 may make available different perspectives in a virtual environment. In addition, virtual environment generator 220 may control what is sometimes referred to as a variation mapping. That is, different virtual models, e.g., according to different nominal geometries, may be provided by virtual model generator 215.

Virtual controls selector 225 provides a mechanism for selecting controls of an input device, e.g., keyboard, mouse, pointing device, etc., that can be used to select various events in the virtual world provided by virtual world generator 205. For example, various aspects of a virtual model could be subject to change according to user input, e.g., a type or location of a gear shift lever, dashboard controls, various styling choices, etc.

Immersive representation generator 230 combines the virtual world provided by virtual world generator 205 with virtual controls provided by virtual controls selector 225, taking into account the location of the user within the virtual world, and the continuously updated position and orientation of the view of the user in the physical world, to provide an immersive representation of a product such as a vehicle. Accordingly, a user, e.g., using display 150, can experience the generated virtual world, and can control aspects of the virtual world using provided virtual controls. The representation is described as immersive because the user generally has no other visual experience other than a view of the virtual world provided by the system 100.

### Exemplary Process Flows

FIG. 9 illustrates is a process flow diagram of an exemplary process 900 for providing a virtual simulation 135.

The process 900 begins in a block 905, in which a CAE model 120 is created. For example, as is known, and as mentioned above, a CAE model 120 may be based on CAD geometries 105 and FEA meshes 110 for a product such as a vehicle. Generally, a CAE model in each file 115 represents a product including its subsystems, e.g., a vehicle and vehicle subsystems, subcomponents, etc.

Next, in a block 910, a CAE simulation is run using the model 115 created in the block 905, thereby generating results in the form of files 120.

Next, in a block 915, results files 120 of the CAE simulation run in the block 910 are post-processed. In general, such post-processing includes analyzing results of the CAE simulation in a two-dimensional environment to verify that the simulation ran without producing any error states.

Next, in a block 920, the virtual simulation generator 130 generates a virtual simulation 135. FIG. 10 provides details of an exemplary process 1000 for generating a virtual simulation 135.

Next, in a block 925, the virtual environment generator 140 is used to generate a virtual reality 145 including the virtual simulation 135. Mechanisms for generating the virtual reality 145 and providing the virtual simulation 135 therein are discussed above with relation to FIG. 2.

Following the block 925, the process 900 ends.

FIG. 10 illustrates is a process flow diagram of an exemplary process 1000 for generating a virtual simulation 135 from a CAE simulation. Generally, steps of the process 1000 are carried out according to computer-executable instructions included in the virtual simulation generator 130.

The process 1000 begins in a block 1005, which generally includes sorting and sequencing of a set of CAE results files 120, e.g., obtained as described above from running a CAE simulation. For example, each file 120 resulting from a CAE simulation may include a sequence number, timestamp, or the like according to which the files 120 may be sequenced. For convenience of processing, each file 120 may be renamed according to its place in the sequence, and a set of files 120 resulting from a given CAE simulation may be saved in a single computer directory.

Next, in a block 1010, the CAE results files 120 sorted and saved in the previous block are pre-processed for use in a virtual simulation 135. For example, it will be understood that surfaces of geometries included in results files 120 data sets may need to be cleaned, normals may need to be unified, etc., so that geometries will be rendered properly in a virtual reality 145. Various software tools exist for performing the pre-processing of the block 1010, e.g., SAP Visual Enterprise Author (formerly Deep Exploration from Right Hemisphere).

Next, in a block 1015, virtual simulation files 125 are generated from the pre-processed results files 120. In one exemplary implementation, results files 120 in VRML format are converted to simulation files 125 in FBX format, i.e., the files 125 are converted for import into the MotionBuilder product mentioned above. Again for ease of processing, the converted simulation files 120 may be saved in a single computer directory with a naming that reflects sequencing of respective corresponding CAE results files 120 as described above.

Next, in a block 1020, each simulation file 125 is cleaned and scaled. For example, the MotionBuilder software product mentioned above may allow for modifying settings for display of a file 125 related to lighting, perspective, etc. Further, carry-over materials included from the files 120 may be deleted. Note, however, that in some circumstances it may be useful to carry over materials, e.g., where they represent strain or contours plots. In addition, scaling and rotation of the data for a particular virtual reality tool such as MotionBuilder for each file 125 may be performed, e.g., scaling by a factor of 0.1, and rotation by 90 degrees along an x-axis in one implementation of the lines scaling and orientation with that of CAD and CAE systems that were used to produce the data set as described above. Once cleaning and scaling is complete for a respective simulation file 125, the file 125 is saved to a directory including a set of files 125 for a simulation 135, e.g., each file may simply overwrite the respective file 125 previously saved as described above with respect to the block 1015.

Next, in a block 1025, eight virtual reality tool may be used to create a virtual simulation 135. For example, the MotionBuilder product includes a “Sequence Animation” interface. The files 125 that were processed as described above in the block 1020 may be selected for the virtual simulation 135. Further, various animation settings may be selected, e.g., a display loop, speed, etc.

Next, in a block 1030, a virtual reality 145 is rendered, including the simulation 135 created as described above in the block 1025. The virtual reality 145 may be provided as described above, e.g., with respect to FIG. 2, with respect to the block 925 of process 900, etc.

Following the block 1030, the process 1000 ends.

### Conclusion

Computing devices such as used for systems and processes disclosed herein, e.g., that store and/or execute instructions included in the virtual simulation generator 130, the virtual environment generator 140, etc., may employ any of a number of computer operating systems known to those skilled in the art, including, but by no means limited to, known versions and/or varieties of the Microsoft Windows® operating system, the Unix operating system (e.g., the Solaris® operating system distributed by Oracle Corporation of Redwood Shores, Calif.), the AIX UNIX operating system distributed by International Business Machines of Armonk, N.Y., the Linux operating system, Apple OS-X Operating Systems, and/or Mobile and Tablet Operating Systems such as Android, from the Open Handset Alliance consortium (including Google), and Apple's iOS for iPad, iPhone and iPod Touch. Computing devices may include any one of a number of computing devices known to those skilled in the art, including, without limitation, a computer workstation, a desktop, notebook, laptop, tablet computer, smartphone, or handheld computer, or some other computing device known to those skilled in the art.

Computing devices such as the foregoing generally each include instructions executable by one or more computing devices such as those listed above. Computer-executable instructions may be compiled or interpreted from computer programs created using a variety of programming languages and/or technologies known to those skilled in the art, including, without limitation, and either alone or in combination, Java™, C, C++, Visual Basic, Java Script, Python, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of known computer-readable media.

A computer-readable medium includes any medium that participates in providing data (e.g., instructions), which may be read by a computer. Such a medium may take many forms, including, but not limited to, non-volatile media, volatile media, and transmission media. Non-volatile media include, for example, optical or magnetic disks and other persistent memory. Volatile media include dynamic random access memory (DRAM), which typically constitutes a main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, Blu-Ray, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

Accordingly, it is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their broadest reasonable constructions and their ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

What is claimed is:

1. A system, comprising a computing device having a processor and a memory, the memory storing instructions executable by the processor such that the computing device is configured to:
receive a set of files in a first format resulting from running a computer simulation;
create a sequence of the files based on an order in which the files relate to the simulation;
convert the files from the first format to a second format, the second format being usable for rendering the files by a virtual reality tool; and
run a virtual simulation in a virtual reality environment using the converted files.

2. The system of claim 1, wherein the computing device is further configured to provide an immersive control to allow a user to view at least a first perspective and a second perspective of the virtual simulation.

3. The system of claim 1, wherein the computing device is further configured to provide controls to perform at least one of starting the virtual simulation, stopping the virtual simulation, re-winding the virtual simulation, and slowing playback of the virtual simulation.

4. The system of claim 1, wherein the computing device is further configured to scale data in the files in the second format according to scaling of the data in the files in the first format.

5. The system of claim 1, wherein the computing device is further configured to display the virtual simulation in context with a virtual world.

6. The system of claim 1, wherein the first format is virtual reality markup language (VRML).

7. The system of claim 1, wherein the computer simulation is of a vehicle crash test.

8. A computer readable medium having instructions executable by a processor tangibly embodied thereon, the instructions including instructions to:
receive a set of files in a first format resulting from running a computer simulation;
create a sequence of the files based on an order in which the files relate to the simulation;
convert the files from the first format to a second format, the second format being usable for rendering the files by a virtual reality tool; and
run a virtual simulation in a virtual reality environment using the converted files.

9. The medium of claim 8, the instructions further including instructions to provide an immersive control to allow a user to view at least a first perspective and a second perspective of the virtual simulation.

10. The medium of claim 8, the instructions further including instructions to provide controls to perform at least one of starting the virtual simulation, stopping the virtual simulation, re-winding the virtual simulation, and slowing playback of the virtual simulation.

11. The medium of claim 8, the instructions further including instructions to scale data in the files in the second format according to scaling of the data in the files in the first format.

12. The medium of claim 8, the instructions further including instructions to display the virtual simulation in context with a virtual world.

13. The medium of claim 8, wherein the first format is virtual reality markup language (VRML).

14. A method, comprising:
receiving a set of files in a first format resulting from running a computer simulation;
creating a sequence of the files based on an order in which the files relate to the simulation converting the files from the first format to a second format, the second format being usable for rendering the files by a virtual reality tool;
running a virtual simulation in a virtual reality environment using the converted files.

15. The system of claim 1, further comprising providing an immersive control to allow a user to view at least a first perspective and a second perspective of the virtual simulation.

16. The system of claim 1, further comprising performing at least one of starting the virtual simulation, stopping the virtual simulation, re-winding the virtual simulation, and slowing playback of the virtual simulation.

17. The system of claim 1, further comprising scaling data in the files in the second format according to scaling of the data in the files in the first format.

18. The system of claim 1, further comprising displaying the virtual simulation in context with a virtual world.

19. The system of claim 1, wherein the first format is virtual reality markup language (VRML).

20. The system of claim 1, wherein the computer simulation is of a vehicle crash test.
